(19) United States
(12) Patent Application Publication
(10) Pub. No.: US 2008/0238619 A1
(43) Pub. Date: Oct. 2, 2008

(54) ACTIVE/PASSIVE RFID TAG

(75) Inventors: Ahmadreza (Reza) Rofougaran, Newport Coast, CA (US); Maryam Rofougaran, Rancho Palos Verdes, CA (US)

Correspondence Address: GARLICK HARRISON & MARKISON, P.O. BOX 160727, AUSTIN, TX, 78716-0727, US

(73) Assignee: BROADCOM CORPORATION, Irvine, CA (US)

(21) Appl. No.: 11/846,828

(22) Filed: Aug. 29, 2007

Related U.S. Application Data
(60) Provisional application No. 60/921,221, filed on Mar. 30, 2007.

(51) Int. Cl. H04B 7/00

(52) U.S. Cl. 340/10.1

(57) ABSTRACT

A radio frequency identification (RFID) tag includes an antenna section, a power recovery circuit, a signal detection circuit, a processing module, a transmitter section, and a battery. The power recovery circuit generates a power supply voltage from an inbound RFID signal and the signal detection circuit recovers an inbound signal from the inbound RFID signal. The processing module interprets the inbound signal, processes the inbound signal in a first manner when the inbound signal is of a first type, generates a battery enable signal when the inbound signal is of a second type, and processes the inbound signal in a second manner when the inbound signal is of the second type. The battery is coupled to provide a battery voltage to power at least a portion of the RFID tag when the battery enable signal is active.

This patent application is claiming priority under 35 USC § 119 to a provisionally filed patent application entitled RFID SYSTEM, having a provisional filing date of Mar. 30, 2007, and a provisional Ser. No. 60/921,221.

### CROSS REFERENCE TO RELATED PATENTS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Technical Field of the Invention

This invention relates generally to communication systems and more particularly to RFID systems.

2. Description of Related Art

A radio frequency identification (RFID) system generally includes a reader, also known as an interrogator, and a remote tag, also known as a transponder. Each tag stores identification data for use in identifying a person, article, parcel or other object. RFID systems may use active tags that include an internal power source, such as a battery, and/or passive tags that do not contain an internal power source, but instead are remotely powered by the reader.

Communication between the reader and the remote tag is enabled by radio frequency (RF) signals. In general, to access the identification data stored on an RFID tag, the RFID reader generates a modulated RF interrogation signal designed to evoke a modulated RF response from a tag. The RF response from the tag includes the coded identification data stored in the RFID tag. The RFID reader decodes the coded identification data to identify the person, article, parcel or other object associated with the RFID tag. For passive tags, the RFID reader also generates an unmodulated, continuous wave (CW) signal to activate and power the tag during data transfer.

Active RFID tags offer the ability to include more memory, more processing resources, and thus are capable of storing and/or processing more data than a passive RFID tag. Such additional storage and/or processing comes at the price of including a battery, which has a limited useful life without some manual intervention (e.g., replace the battery or charge the battery). As such, an active RFID tag has a corresponding limited useful life, while a passive RFID tag has an unlimited useful life. In addition, due to including a battery and increasing the memory and/or processing of an active RFID tag, it costs more than a passive RFID tag.

Depending on the application of an RFID system, it may be desirable to use active RFID tag in some instances and a passive RFID tag in other instances. For example, if an RFID tag is affiliated with an electronic device, it may desirable to use a passive RFID tag to process simple RFID operations (e.g., verify user information, verify status, etc.) and to use an active RFID tag to process more complex RFID operations (e.g., facilitate diagnostics, etc.). One solution is to affiliate a passive and active RFID tag with the electron device, which has the obvious flaws of including two RFID tags and coordinating communication therewith.

Therefore, a need exists for an active/passive RFID tag that over comes at least some of the above mentioned issues and may further overcome other issues.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a schematic block diagram of an embodiment of an RFID system in accordance with the present invention;

FIG. 2 is a schematic block diagram of an embodiment of an RFID tag in accordance with the present invention;

FIG. 3 is a schematic block diagram of another embodiment of an RFID tag in accordance with the present invention;

FIG. 4 is a schematic block diagram of another embodiment of an RFID tag in accordance with the present invention;

FIG. 5 is a schematic block diagram of another embodiment of an RFID tag in accordance with the present invention;

FIG. 6 is a schematic block diagram of another embodiment of an RFID tag in accordance with the present invention;

FIG. 7 is a schematic block diagram of another embodiment of an RFID tag in accordance with the present invention;

FIG. 8 is a schematic block diagram of another embodiment of an RFID tag in accordance with the present invention; and

FIG. 9 is a logic diagram of an embodiment of a method of operation of an RFID tag in accordance with the present invention.

### DETAILED DESCRIPTION OF THE INVENTION

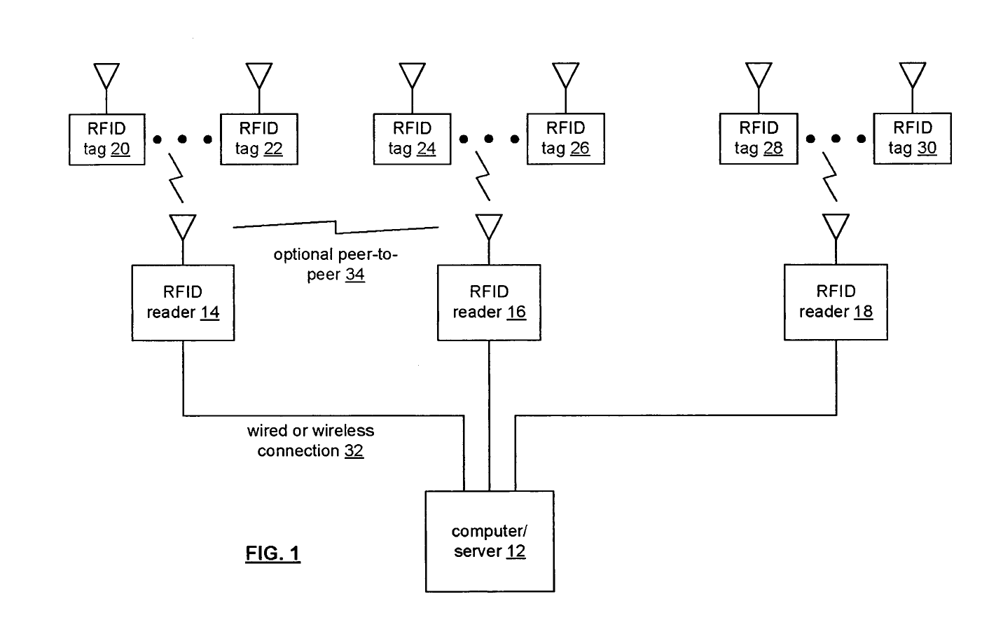

FIG. 1 is a schematic block diagram of an RFID (radio frequency identification) system that includes a computer/server 12, a plurality of RFID readers 14-18 and a plurality of RFID tags 20-30. The RFID tags 20-30 may each be associated with a particular object for a variety of purposes including, but not limited to, tracking inventory, tracking status, location determination, assembly progress, et cetera. The RFID tags may be active devices, passive devices, and/or devices as described in the following figures.

Each RFID reader 14-18 wirelessly communicates with one or more RFID tags 20-30 within its coverage area. For example, RFID tags 20 and 22 may be within the coverage area of RFID reader 14, RFID tags 24 and 26 may be within the coverage area of RFID reader 16, and RFID tags 28 and 30 may be within the coverage area of RFID reader 18. In one embodiment, the RF communication scheme between the RFID readers 14-18 and RFID tags 20-30 is a backscatter technique whereby the RFID readers 14-18 request data from the RFID tags 20-30 via an RF signal, and the RF tags 20-30 respond with the requested data by modulating and backscattering the RF signal provided by the RFID readers 14-18. In another embodiment, the RF communication scheme between the RFID readers 14-18 and RFID tags 20-30 is an inductance technique whereby the RFID readers 14-18 magnetically couple to the RFID tags 20-30 via an RF signal to access the data on the RFID tags 20-30. In either embodiment, the RFID tags 20-30 provide the requested data to the RFID readers 14-18 on the same, or near the same, RF carrier frequency as the RF signal.

In this manner, the RFID readers 14-18 collect data as may be requested from the computer/server 12 from each of the RFID tags 20-30 within its coverage area. The collected data is then conveyed to computer/server 12 via the wired or wireless connection 32 and/or via peer-to-peer communication 34. In addition, and/or in the alternative, the computer/server 12 may provide data to one or more of the RFID tags 20-30 via the associated RFID reader 14-18. Such downloaded information is application dependent and may vary greatly. Upon receiving the downloaded data, the RFID tag can store the data in a non-volatile memory therein.

As indicated above, the RFID readers 14-18 may optionally communicate on a peer-to-peer basis such that each RFID reader does not need a separate wired or wireless connection 32 to the computer/server 12. For example, RFID reader 14 and RFID reader 16 may communicate on a peer-to-peer basis utilizing a back scatter technique, a wireless LAN technique, and/or any other wireless communication technique. In this instance, RFID reader 16 may not include a wired or wireless connection 32 to computer/server 12. In embodiments in which communications between RFID reader 16 and computer/server 12 are conveyed through the wired or wireless connection 32, the wired or wireless connection 32 may utilize any one of a plurality of wired standards (e.g., Ethernet, fire wire, et cetera) and/or wireless communication standards (e.g., IEEE 802.11x, Bluetooth, et cetera).

As one of ordinary skill in the art will appreciate, the RFID system of FIG. 1 may be expanded to include a multitude of RFID readers 14-18 distributed throughout a desired location (for example, a building, office site, et cetera) where the RFID tags may be associated with equipment, inventory, personnel, et cetera. In addition, it should be noted that the computer/server 12 may be coupled to another server and/or network connection to provide wide area network coverage.

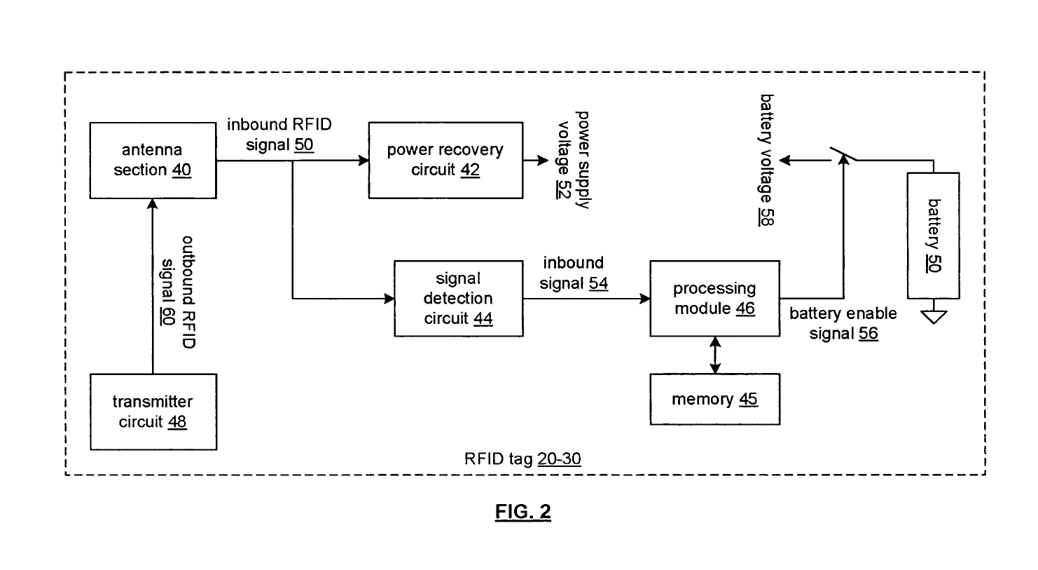

FIG. 2 is a schematic block diagram of an embodiment of an RFID tag 20-30 that includes an antenna section 40, a power recovery circuit 42, a signal detection circuit 44, memory 45, a processing module 46, a transmitter circuit 48, and a battery 50. The processing module 46 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module may have an associated memory 45 and/or memory element, which may be a single memory device, a plurality of memory devices, and/or embedded circuitry of the processing module. Such a memory device may be a read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Further note that, the memory element stores, and the processing module executes, hard coded and/or operational instructions corresponding to at least some of the steps and/or functions illustrated in FIGS. 2-9.

The antenna section 40, which may include one or more mono-pole or dipole antennas and may further include a transmission line, an impedance matching circuit, and/or a transformer balun, is coupled to receive an inbound RFID signal 50 and/or to transmit an outbound RFID signal 60. The inbound RFID signal 50 is received from an RFID reader and may include a command (e.g., store data, delete data, transfer data, read data, modify, etc.), an inquiry (e.g., status, identification, etc.), and/or other type of instruction (e.g., initiate a diagnostic, perform a computation, etc.). The antenna section 40 provides the inbound RFID signal 50 to the power recovery circuit 42 and to the signal detection circuit 44.

The power recovery circuit 42 is coupled to generate a power supply voltage 52 from the inbound RFID signal 50. In one embodiment, the power recovery circuit 42 includes a rectifying module, which may be an active cell rectifier or a charge pump rectifier, and a tuning module. The tuning module is coupled to tune the rectifying module in accordance with the RFID signal 50. In other words, the tuning module tunes the frequency response of the rectifying module based on the frequency of the RFID signal such that the frequency response of the power recovery circuit 42 is optimized for the RFID signal 50.

Being at least initially powered by the power supply voltage 52, the signal detection circuit 44, which may be an envelop detector, an AM demodulator, and/or any other type of demodulator corresponding to the modulation scheme utilized by the RFID reader to modulate data of the inbound RFID signal 50, is coupled to recover an inbound signal 54 from the inbound RFID signal 50. The inbound signal 54 may be a command, an inquiry, and/or an instruction. The signal detection circuit 44 provides the inbound signal 54 to the processing module 46.

Being at least initially powered by the power supply voltage 52, the processing module 46 interprets the inbound signal 54 to determine its type. For example, the inbound signal may be at a first level when the processing requirements correspond to the processing capabilities of a passive RFID tag (e.g., a passive tag can generate enough power to sufficiently process the command, inquiry, and/or instruction) or the inbound signal may be of a second level when the processing requirements exceed the processing capabilities of the passive RFID tag. When the inbound signal 54 is of a first type, the processing module 46 processes the inbound signal 54 (e.g., the command, the inquiry, and/or the instruction) in a first manner (e.g., as a passive RFID tag).

When the inbound signal 54 is of a second type, the processing module 46 generates a battery enable signal 56, which enables the battery 50 to provide a battery voltage 58 to the RFID tag. In addition, the processing module 46 processes the inbound signal 54 in a second manner (e.g., as an active RFID tag). As such, when the RFID tag needs additional power for additional memory operations and/or processing operations, the battery 50 is coupled to the processing module 46, the memory 45, the signal detection circuit 44, and/or to the transmitter circuit 48. In this instance, the benefits of active RFID tag are achieved with minimal drain on the battery, thereby substantially increasing the useful life of the battery.

The transmitter circuit 48 is coupled to generate the outbound RFID signal 60 based on information provided by the processing module 46. For example, the information may be a response to the inbound signal 54. While not shown, the RFID tag 20-30 may further include a clock circuit that generates a clock signal for the processing module and other circuitry of the tag.

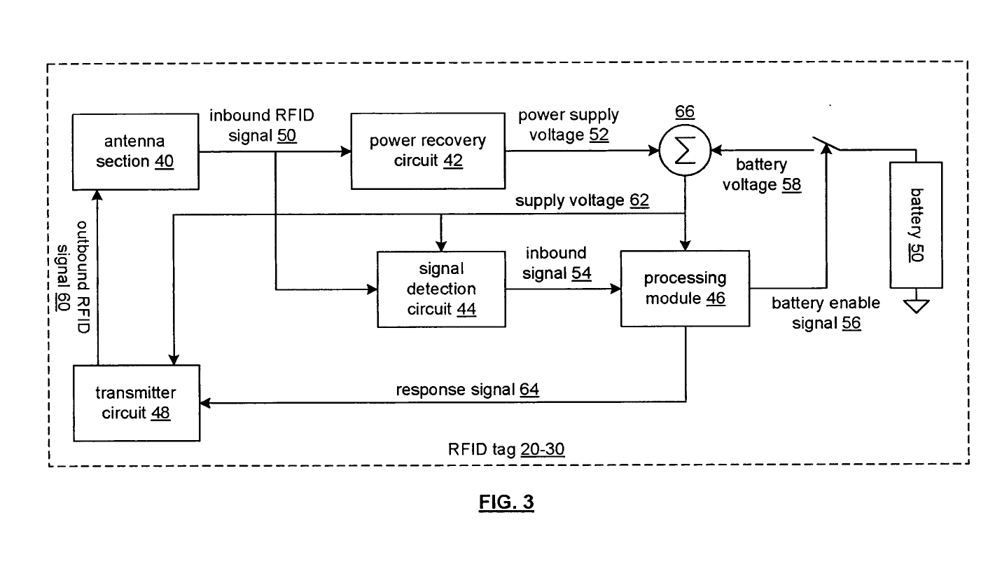

FIG. 3 is a schematic block diagram of another embodiment of an RFID tag 20-30 that includes an antenna section 40, a power recovery circuit 42, a signal detection circuit 44, memory 45, a processing module 46, a transmitter circuit 48, a battery 50, and a power combining module 66. In this embodiment, the power combining module 66, which may be a voltage switch, a connecting wire, and/or a voltage summer, outputs the power supply voltage 52 when the battery enable signal 56 is not enabled to produce a supply voltage 62 that supplies the transmitter circuit 48, the signal detection circuit 44, the processing module 46, and the memory 45.

When the battery enable signal 56 is enabled, the power combining module 66 provides the battery voltage 58 or a combination of the battery voltage 58 and the power supply voltage 52 as the supply voltage 62. For example, if the power combining module 66 is a voltage switch, then, when the battery enable signal 56 is enabled, the switch transitions states to output the battery voltage.

Regardless of the power, the processing module 46 may generate a response signal 64 (e.g., an ACK, a message with retrieved data, a message with a result of a computation, etc.) in accordance with the inbound signal 54. The transmitter circuit 48 may use a backscatter technique to transmit the response signal 64 via the antenna section 40.

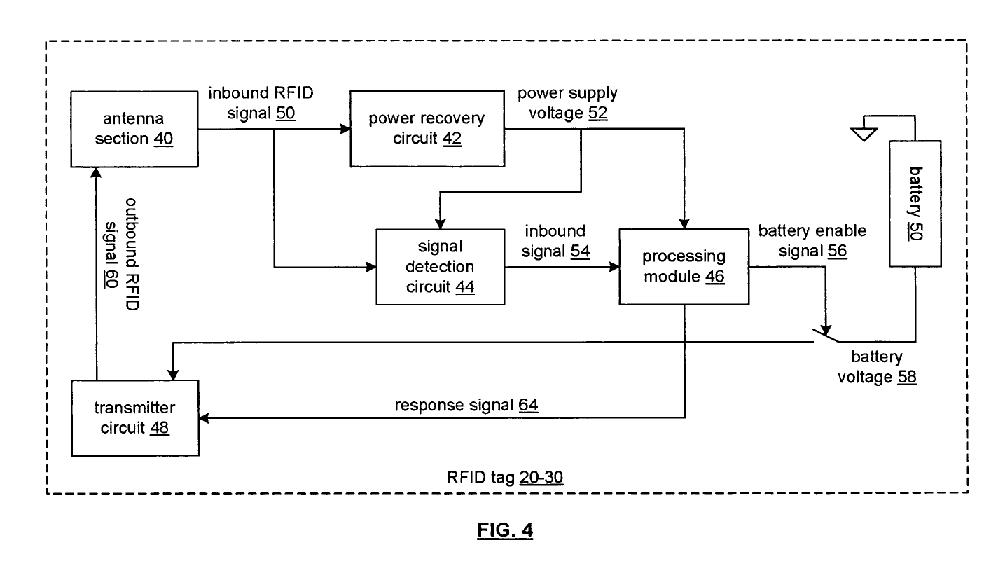

FIG. 4 is a schematic block diagram of another embodiment of an RFID tag 20-30 that includes an antenna section 40, a power recovery circuit 42, a signal detection circuit 44, memory 45, a processing module 46, a transmitter circuit 48, and a battery 50. In this embodiment, the signal detection circuit 44, the memory 45, and the processing module 46 are powered via the power supply voltage 52. When the processing module 46 has data to transmit it may activate the battery enable signal 56 such that the battery 50 supplies the battery voltage 58 to the transmitter circuit 48. As an example, the processing module 46 may activate the battery enable signal 56 each time it has data to transmit. As another example, the processing module 46 may activate the battery enable signal 56 when the inbound signal 54 indicates a higher transmit power and/or whenever the processing module 46 determines that it needs a higher transmit power.

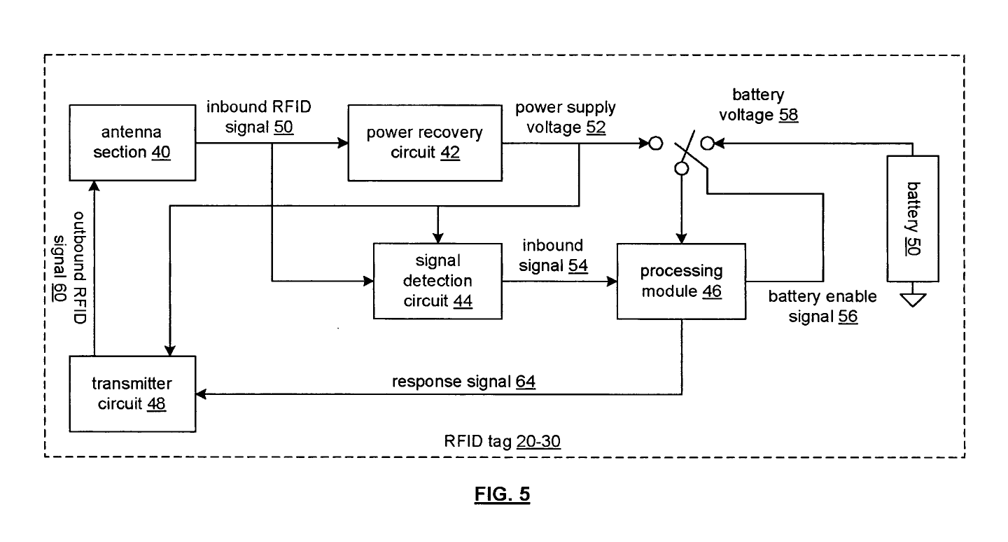

FIG. 5 is a schematic block diagram of another embodiment of an RFID tag 20-30 that includes an antenna section 40, a power recovery circuit 42, a signal detection circuit 44, a processing module 46, a transmitter circuit 48, and a battery 50. In this embodiment, the signal detection circuit 44, and the transmitter circuit 48 are powered via the power supply voltage 52. The processing module 46 is powered either via the power supply voltage 52 or the battery voltage 58. For instance, when the processing module 46 is processing the inbound signal 54 in the first manner the battery enable signal is inactive and, as such, it receives its power from the power supply voltage 52. When, however, the processing module is processing the inbound signal 54 in the second manner, the battery signal is active and, as such, it receives it power from the battery voltage 58. Note that while the memory 45 is not shown in this embodiment, the processing module 46 may determine when to power the memory 45 from the power supply voltage 52 or from the battery voltage 58.

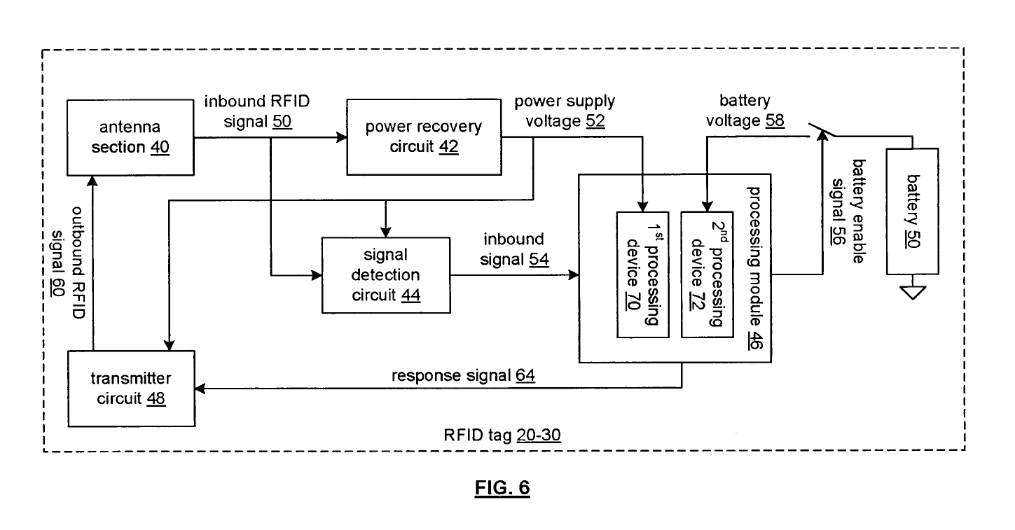

FIG. 6 is a schematic block diagram of another embodiment of an RFID tag 20-30 that includes an antenna section 40, a power recovery circuit 42, a signal detection circuit 44, a processing module 46, a transmitter circuit 48, and a battery 50. In this embodiment, the processing module 46 includes a first processing device 70 and a second processing device 72. The first processing device 70 processes the inbound signal 54 when the inbound signal is of the first type (e.g., the RFID tag can function properly as a passive tag). The second processing device 72 processes the inbound signal 54 when the inbound signal is of the second type (e.g., the RFID tag should function similarly to an active tag). For example, the first processing device 70 may be a low power, low performance state machine, DSP, microprocessor, or microprocessing core, while the second processing device 72 is a higher power, higher performance state machine, DSP, microprocessor, or microprocessing core.

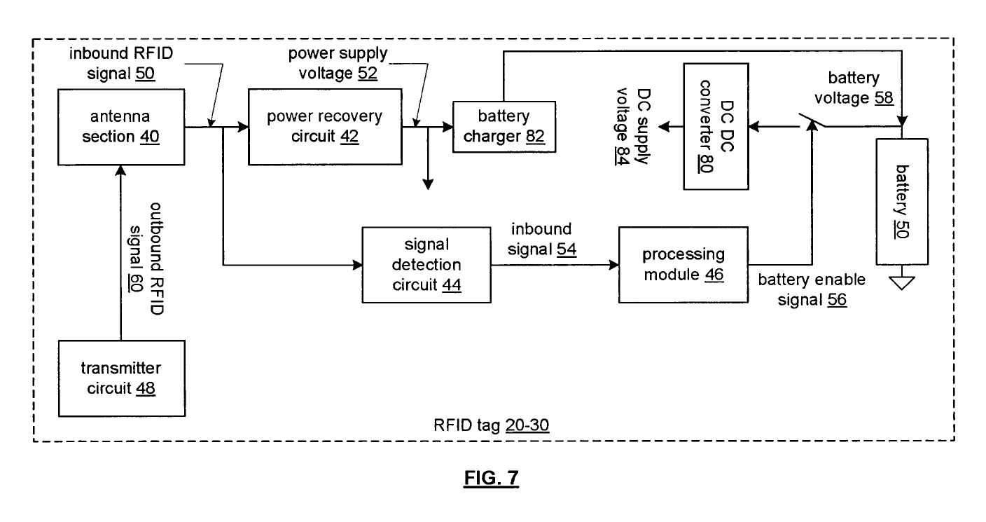

FIG. 7 is a schematic block diagram of another embodiment of an RFID tag 20-30 that includes an antenna section 40, a power recovery circuit 42, a signal detection circuit 44, a processing module 46, a transmitter circuit 48, and a battery 50. The RFID tag may further include a battery charger 82 and/or a DC-DC converter 84. In an embodiment, when the battery enable signal 56 is active, the DC-DC converter 84 converts the battery voltage 58 into one or more DC voltages 84. The one or more DC voltages 84 may be used to power the transmitter circuit 48, the processing module 46, and/or the signal detection module 44.

If the RFID tag includes the battery charger 82, the battery charger 82 generates a battery charge current from the power supply voltage 52 when it is enabled. The battery charger 82 may be enabled whenever the battery enable signal 56 is inactive, whenever the power recovery circuit 42 is producing the power supply voltage 52, and/or as controlled by the processing module 46.

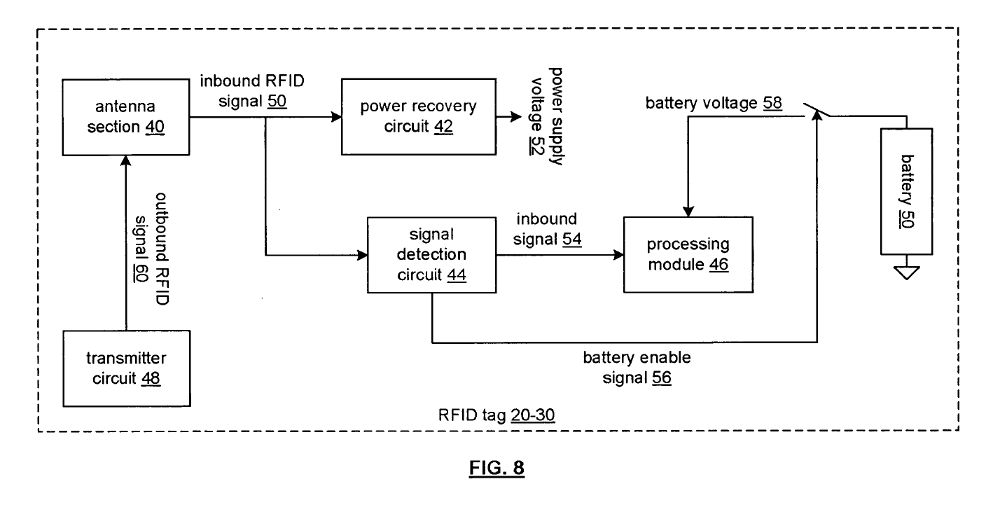

FIG. 8 is a schematic block diagram of another embodiment of an RFID tag 20-30 that includes an antenna section 40, a power recovery circuit 42, a signal detection circuit 44, a processing module 46, a transmitter circuit 48, and a battery 50. In this embodiment, the antenna section 40 is coupled to receive a radio frequency (RF) signal, which may include an RFID signal 50 or any RF signal having a carrier frequency near the carrier frequency of the RFID signal 50 (e.g., 900 MHz). The power recovery circuit 42 is coupled to generate the power supply voltage 52 from the RF signal.

The signal detection circuit 44 is powered via the power supply voltage 52 to determine whether the RF signal includes an RFID signal component 50. When the RF signal includes the RFID signal 50, the signal detection circuit 44 provides an indication thereof to the processing module 46. For example, the signal detection circuit 44 may perform a correlation function with a known pattern (e.g., preamble) of a valid RFID signal.

When the RFID signal 50 is present, a battery circuit (e.g., the battery 50 and the corresponding switch) provides a battery voltage 58 to one or more of the processing module 46, the transmitter circuit 48, and the signal detection circuit 44. When the RFID signal is not detected, the battery switch is open.

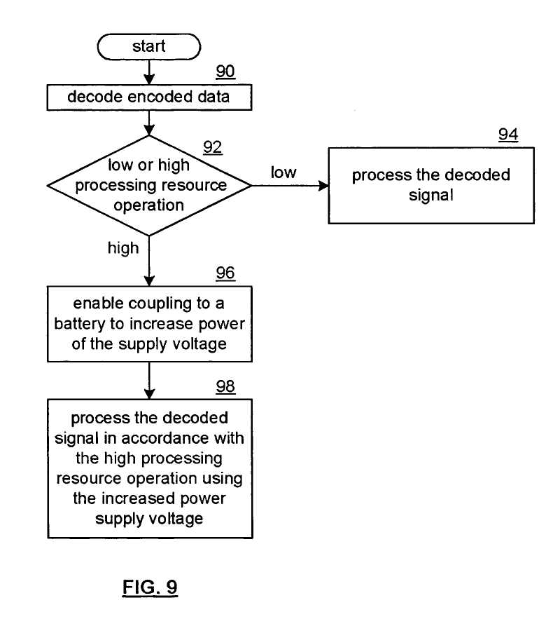

FIG. 9 is a logic diagram of an embodiment of a method of operation of an RFID tag. The method begins at step 90 where the processing module decodes the encoded data (e.g., the inbound signal 54) to produce a decoded signal. The method then proceeds to step 92 where the processing module determines whether the processing of the decoded signal is a low processing resource operation or a high processing resource operation. Note that the high processing resource operation including at least one of: enabling additional microprocessing capabilities of the processing module and processing of the decode signal exceeds a power-time ratio of the supply voltage 52 (e.g., for the process to be performed, the power supply voltage is insufficient to power the processing module 46).

When the processing of the decoded signal is the low processing resource operation, the method proceeds to step 94 where processing module 46 processes the decoded signal while being powered via the power supply voltage 52. When the processing of the decoded signal is the high processing resource operation, the method proceeds to step 96 where the processing module 46 enables coupling of the battery 50 to increase power of the supply voltage 52 to produce an increased power supply voltage. The method then proceeds to step 98 where the processing module processes the decoded signal in accordance with the high processing resource operation using the increased power supply voltage. Note that the processing of the decoded signal includes generating a response signal, storing received data contained in the decoded signal, and/or executing a delete, modify, or transfer command.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. A radio frequency identification (RFID) tag comprises:
an antenna section coupled to receive an inbound RFID signal and to transmit an outbound RFID signal;
a power recovery circuit coupled to generate a power supply voltage from the inbound RFID signal;
a signal detection circuit coupled to recover an inbound signal from the inbound RFID signal;
a processing module coupled to:
interpret the inbound signal;
process the inbound signal in a first manner when the inbound signal is of a first type;
generate a battery enable signal when the inbound signal is of a second type; and
process the inbound signal in a second manner when the inbound signal is of the second type;
a transmitter circuit coupled to generate the outbound RFID signal; and
a battery coupled to provide a battery voltage to power at least a portion of the RFID tag when the battery enable signal is active.

2. The RFID tag of claim 1 further comprises:
a battery charger coupled to derive a battery charge current from the power supply voltage when the battery charger is enabled.

3. The RFID tag of claim 1 further comprises:
a DC-DC converter coupled to convert the battery voltage into one or more DC voltage supplies.

4. The RFID tag of claim 1, wherein the processing module comprises:
a first processing device for processing the inbound signal when the inbound signal is of the first type; and
a second processing device for processing the inbound signal when the inbound signal is of the second type.

5. The RFID tag of claim 1 further comprises:
the first type is a low processing resource function; and
the second type is a high processing resource function.

6. The RFID tag of claim 1, wherein the first or second manner of processing the inbound signal comprises at least one of:
generating a response signal;
storing received data contained in the inbound signal; and
executing a delete, modify, or transfer command.

7. The RFID tag of claim 1 further comprises:
the battery providing the battery voltage to the transmitter circuit in accordance with the battery enable signal.

8. The RFID tag of claim 1 further comprises:
the battery providing the battery voltage to the processing module in accordance with the battery enable signal.

9. A radio frequency identification (RFID) tag comprises:
a power generating and signal detection module coupled to convert an inbound radio frequency (RF) signal into a supply voltage and to recover encoded data from the RF signal;
a processing module coupled to:
decode the encoded data to produce a decoded signal;
interpret the decoded signal to determine whether processing of the decoded signal is a low processing resource operation or a high processing resource operation;
when the processing of the decoded signal is the low processing resource operation, process the decoded signal;
when the processing of the decoded signal is the high processing resource operation, enable coupling to a battery to increase power of the supply voltage to produce an increased power supply voltage; and
process the decoded signal in accordance with the high processing resource operation using the increased power supply voltage; and
an antenna section coupled to receive the inbound RF signal.

10. The RFID tag of claim 9 further comprises:
the high processing resource operation including at least one of: enabling additional microprocessing capabilities of the processing module and processing of the decode signal exceeds a power-time ratio of the supply voltage.

11. The RFID tag of claim 9, wherein the processing of the decoded signal comprises:
generating a response signal;
storing received data contained in the decoded signal; and
executing a delete, modify, or transfer command.

12. The RFID tag of claim 11 further comprises:
a transmitter circuit coupled to generate an outbound RFID signal from the response signal or response to the delete, modify, or transfer command, wherein the antenna section transmits the outbound RFID signal.

13. The RFID tag of claim 9 further comprises:
a battery charger coupled to derive a battery charge current from the supply voltage when the battery charger is enabled.

14. The RFID tag of claim 9 further comprises:
a DC-DC converter coupled to convert a battery voltage of the battery into one or more DC voltage supplies when coupling to the battery is enabled.

15. A radio frequency identification (RFID) tag comprises:
an antenna section coupled to receive a radio frequency (RF) signal;
a power recovery circuit coupled to generate a power supply voltage from the RF signal;
a signal detection circuit powered via the power supply voltage to determine whether the RF signal includes an RFID signal component and to provide an indication of the RFID signal component when the RFID signal component is detected;
a battery circuit coupled to provide a battery voltage when the indication of the RFID signal component is in a first state; and
a processing module powered via a representation of the battery voltage to process the RFID signal component.

16. The RFID of claim 15 further comprises:
a battery charger coupled to derive a battery charge current from the power supply voltage when the battery charger is enabled.

17. The RFID tag of claim 15 further comprises:
a DC-DC converter coupled to convert the battery voltage into one or more DC voltage supplies as the representation of the battery voltage.

18. The RFID tag of claim 15, wherein the processing the RFID signal component comprises at least one of:
generating a response signal;
storing received data contained in the inbound signal; and
executing a delete, modify, or transfer command.

19. The RFID tag of claim 18 further comprises:
a transmitter circuit coupled to generate an outbound RFID signal from the response signal or response to the delete, modify, or transfer command, wherein the antenna section transmits the outbound RFID signal.
